(19) United States
(12) Patent Application Publication
(10) Pub. No.: US 2003/0232733 A1
(43) Pub. Date: Dec. 18, 2003

(54) Preserved enhancement of bleaching catalysts

(75) Inventors: Adrianus Cornelis Appel, Vlaardingen (NL); Ronald Hage, Vlaardingen (NL); Roelant Mathijs Hermant, Vlaardingen (NL); Joachim Lienke, Vlaardingen (NL); Simon Marinus Veerman, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/454,465

(22) Filed: Jun. 4, 2003

(30) Foreign Application Priority Data
Jun. 6, 2002 (GB) 0212984.9

(51) Int. Cl. C11D 3/00

(52) U.S. Cl. 510/302; 510/309; 510/311; 510/375

(57) ABSTRACT

The present invention provides a catalytic bleaching system that is low in surfactant alkyl hydroperoxide and comprises an antioxidant.

### FIELD OF INVENTION

This invention relates to the enhancement of bleaching compositions that are substantially devoid of peroxyl species.

### BACKGROUND OF INVENTION

The use of bleaching catalysts for stain removal has been developed over recent years. The recent discovery that some catalysts are capable of bleaching effectively in the absence of an added peroxyl source has recently become the focus of some interest, for example: WO9965905; WO0012667; WO0012808; WO0029537, and, WO0060045.

Ways of enhancing the activity or improving the stain bleaching profile of these catalysts are desired.

### SUMARY OF INVENTION

The bleaching of a stain by a peroxyl species is aided by the presence of an active transition metal catalyst. A peroxyl species commonly found in laundry bleaching compositions is hydrogen peroxide (H₂O₂) or a precursor thereof, e.g., sodium percarbonate or sodium perborate. In many instances an activator/precursor, e.g., TAED (tetraacetylethylene diamine), is present which serves together with hydrogen peroxide to form a peracid [RC(O)OOH] to facilitate bleaching.

Recently we have found that oily stains are bleached in the presence of selected transition metal catalysts in the absence of an added peroxyl source. The bleaching of an oily stain in the absence of an added peroxyl source has been attributed to oxygen derived from the air. Whilst it is true that bleaching is effected by oxygen sourced from the air the route in which oxygen plays a part is becoming understood.

We have concluded from our research that bleaching of a chromophore in an oily stain is effected by products formed by adventitious oxidation of components in the oily stain. These products, alkyl hydroperoxides, are generated naturally by autoxidation of the oily stain and the alkyl hydroperoxides together with a transition metal catalyst serve to bleach chromophores in the oily stain. Alkyl hydroperoxides (ROOH) are generally less reactive that other peroxy species, for example, peracids (RC(O)OOH), hydrogen peroxide (H2O2), percarbonates and perborates.

A surfactant will migrate to a hydrophilic/hydrophobic interface in an aqueous washing medium. In this regard, because the catalysts serve to bleach with alkyl hydroperoxides found in a stain, a consequence of keeping the surfactant as low as possible in alkyl hydroperoxide content is that bleaching is focused on the oily stain where the alkyl hydroperoxides occur and bleaching is minimised elsewhere.

The low level of surfactant hydroperoxide also serves to preserve the integrity of the transition metal catalyst. In addition, by keeping the alkyl hydroperoxide level low, peroxide-catalyst interaction is reduced when the composition is in the form of a liquid, be it in a wash or as a commercial liquid formulation.

A problem with the detergent composition is that of maintaining the low level of surfactant HPO or reducing further autoxidation of the surfactant present during storage. The presence of an antioxidant in the detergent composition reduces further autoxidation of the surfactant present during storage.

The present invention provides a bleaching composition comprising at least 0.0001% wt/wt of an antioxidant, 1 to 60% wt/wt of a surfactant and an organic substance which forms a complex with a transition metal for bleaching an oily stain the bleaching composition upon addition to an aqueous medium providing an aqueous bleaching medium substantially devoid of a peroxygen bleach or a peroxy-based or peroxyl-generating bleach system, the total surfactant contribution with a HLB greater than 10 having a hydroperoxide content (HPO) of less than 100 mMol/Kg, preferably less than 50 mMol/Kg, most preferably less than 15 mMol/kg.

The peroxide level of surfactant having a surfactant-peroxide level is expressed in mMol of hydroperoxide (—OOH) present per Kg.

The term “substantially devoid of a peroxygen bleach or a peroxy-based or peroxyl-generating bleach system” should be construed within spirit of the invention. It is preferred that the composition has as low a content of peroxyl species present as possible. It is preferred that the bleaching formulation contains less that 1% wt/wt total concentration of peracid or hydrogen peroxide or source thereof, preferably the bleaching formulation contains less that 0.3% wt/wt total concentration of peracid or hydrogen peroxide or source thereof, most preferably the bleaching composition is devoid of peracid or hydrogen peroxide or source thereof.

The surfactant has an HLB (hydrophilic/lipophilic balance) greater that 5, more preferably greater than 10, and most preferably greater than 15. For a discussion of HLB the reader is directed to and article by Griffin, W. C. in J. Soc. Cosmetic Chemists Vol. 1 page 311, 1945 and Davies, J. T. and Rideal, E. K. in Interfacial Phenomena, Acad. Press, NY, 1961, pages 371 to 382. The HLB value requirement reflects the importance of the rate of solubility and dispersibility of the surfactant present from the bleaching composition to the aqueous wash medium in conjunction with surface activity towards the substrate being washed. The threshold value of HLB as required excludes compounds that do not have the required surfactant properties, for example linoleaic or oleic acid have an HLB of 0.8.

It is preferred that the bleaching composition comprises at least 10% wt/wt, preferably 15%, most preferably 20%, of the total surfactant contribution having an HLB greater than 10.

The present invention extends to a method of bleaching a substrate comprising applying to the substrate, in an aqueous medium, the bleaching composition according to the present invention.

The present invention extends to a commercial package comprising the bleaching composition according to the present invention together with instructions for its use.

The bleaching composition may be contacted to the textile fabric in any suitable manner. For example, it may be applied in dry form, such as in powder form, or in a liquor that is then dried, for example as an aqueous spray-on fabric treatment fluid or a wash liquor for laundry cleaning, or a non-aqueous dry cleaning fluid or spray-on aerosol fluid.

Any suitable textile that is susceptible to bleaching or one that one might wish to subject to bleaching may be used. Preferably the textile is a laundry fabric or garment.

In a preferred embodiment, the method according to the present invention is carried out on a laundry fabric using an aqueous treatment liquor. In particular, the treatment may be effected in a wash cycle for cleaning laundry. More preferably, the treatment is carried out in an aqueous detergent bleach wash liquid.

In a preferred embodiment, the treated textile is dried, by allowing it to dry under ambient temperature or at elevated temperatures. The elevated temperatures are commonly provided by a heated agitated environment, as for example found in a tumble dryer, which has been found to accelerate and enhance the air bleaching effect. The effect of ironing the treated textile also serves to accelerate bleaching.

The bleaching method may be carried out by simply leaving the substrate in contact with the bleaching composition for a sufficient period of time. Preferably, however, the bleaching composition is in an aqueous medium, and the aqueous medium on or containing the substrate is agitated.

The bleaching composition may be contacted with the textile fabric in any conventional manner. For example it may be applied in dry form, such as in powder form, or in a liquor that is then dried, for example in an aqueous spray-on fabric treatment fluid or a wash liquor for laundry cleaning, or a non-aqueous dry cleaning fluid or spray-on aerosol fluid.

In a particularly preferred embodiment the method according to the present invention is carried out on a laundry fabric using aqueous treatment liquor. In particular the treatment may be effected in, or as an adjunct to, an essentially conventional wash cycle for cleaning laundry. More preferably, the treatment is carried out in an aqueous detergent wash liquor. The bleaching composition can be delivered into the wash liquor from a powder, granule, pellet, tablet, block, bar or other such solid form. The solid form can comprise a carrier, which can be particulate, sheet-like or comprise a three-dimensional object. The carrier can be dispersible or soluble in the wash liquor or may remain substantially intact. In other embodiments, the bleaching composition can be delivered into the wash liquor from a paste, gel or liquid concentrate.

A unit dose as used herein is a particular amount of the bleaching composition used for a type of wash. The unit dose may be in the form of a defined volume of powder, granules or tablet.

It is preferred that a unit dose provides at least 0.05 g/l, preferably 0.1 g/l, most preferably 0.2 g/l, concentration of the surfactant compound in a wash. Ideally, a unit dose in an aqueous medium provides aqueous medium having an HPO not greater than 10 μM.

### DETAILED DESCRIPTION OF THE INVENTION

Antioxidant

The compositions of the present invention comprise an effective amount of the anti-oxidant, at least 0.0001% wt/wt, preferably from about 0.001% more preferably from about 0.1%, most preferably from about 0.2% to about 10%, preferably to about 5%, more preferably to about 1% by weight of an anti-oxidant. Anti-oxidants are substances as described in Kirk-Othmers (Vol 3, pg 424) and in Uhlmans Encyclopedia (Vol 3, pg 91).

One class of anti-oxidants suitable for use in the present invention is alkylated phenols having the general formula:

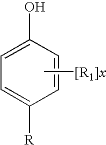

wherein R is C1-C22 linear or branched alkyl, preferably methyl or branched C3-C6 alkyl; C3-C6 alkoxy, preferably methoxy; R1 is a C3-C6 branched alkyl, preferably tert-butyl; x is 1 or 2. Hindered phenolic compounds are preferred as antioxidant.

Another class of anti-oxidants suitable for use in the present invention is a benzofuran or benzopyran derivative having the formula:

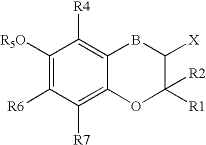

wherein R1 and R2 are each independently alkyl or R1 and R2 can be taken together to form a C5-C6 cyclic hydrocarbyl moiety; B is absent or CH2; R4 is C1-C6 alkyl; R5 is hydrogen or —C(O)R3 wherein R3 is hydrogen or C1-C19 alkyl; R6 is C1-C6 alkyl; R7 is hydrogen or C1-C6 alkyl; X is —CH2OH, or —CH2A wherein A is a nitrogen comprising unit, phenyl, or substituted phenyl. Preferred nitrogen comprising A units include amino, pyrrolidino, piperidino, morpholino, piperazino, and mixtures thereof.

Other suitable antioxidants are found as follows. A derivative of α-tocopherol, 6-hydroxy-2,5,7,8-tetra-methylchroman-2-carboxylic acid (Trolox™). Anti-oxidants/radical scavengers such as ascorbic acid (vitamin C) and its salts, tocopherol (vitamin E), tocopherol sorbate, other esters of tocopherol, butylated hydroxy benzoic acids and their salts, gallic acid and its alkyl esters, especially propyl gallate, uric acid and its salts and alkyl esters, sorbic acid and its salts, the ascorbyl esters of fatty acids, amines (e.g., N,N-diethylhydroxylamine, amino-guanidine), sulfhydryl compounds (e.g., glutathione), and dihydroxy fumaric acid and its salts may be used.

Non-limiting examples of anti-oxidants suitable for use in the present invention include phenols inter alia 2,6-di-tert-butylphenol, 2,6-di-tert-butyl-4-methylphenol, mixtures of 2 and 3-tert-butyl-4-methoxyphenol, and other ingredients including include propyl gallate, tert-butylhydroquinone, benzoic acid derivatives such as methoxy benzoic acid, methylbenzoic acid, dichloro benzoic acid, dimethyl benzoic acid, 5-hydroxy-2,2,4,6,7-pentamethyl-2,3-dihydro-1-benzofuran-3-one, 5-hydroxy-3-methylene-2,2,4,6,7-pentamethyl-2,3-dihydro-benzofuran, 5-benzyloxy-3-hydroxymethyl-2,2,4,6,7-pentamethyl-2,3-dihydro-1-benzofuran, 3-hydroxymethyl-5-methoxy-2,2,4,6,7-pentamethyl-2,3-dihydro-1-benzofuran, vitamin C(ascorbic acid), and Ethoxyquine (1,2-dihydro-6-ethoxy-2,2,4-trimethylchinolin) marketed under the name Raluquin™ by the company Raschig™.

Preferred radical scavengers for use herein include di-tert-butyl hydroxy toluene (BHT), α-tocopherol. hydroquinone, 2,2,4-trimethyl-1,2-dihydroquinoline, di-tert-butyl hydroquinone, mono-tert-butyl hydroquinone, tert-butyl-hydroxy anisole, benzoic acid and derivatives thereof, like alkoxylated benzoic acids, as for example, trimethoxy benzoic acid (TMBA), toluic acid, catechol, t-butyl catechol, benzylamine, 1,1,3-tris (2-methyl-4-hydroxy-5-t-butylphenyl) butane, N-propyl-gallate or mixtures thereof and highly preferred is di-tert-butyl hydroxy toluene.

It is preferred that at least two antioxidants are present in the composition in a molar ratio of at least 5%, preferably at least 10%, most preferably 25%. The mixture of the two antioxidants providing a greater degree of antioxidant activity that the molar sum of the two antioxidants.

The Surfactant

Many surfactants are susceptible to autoxidation to form hydroperoxides. Surfactants containing an allylic hydrogen, a hydrogen alpha to an ether or an benzylic hydrogen are particularly susceptible to autoxidation.

One skilled in the art will appreciate that benzene is considered unsaturated but does not contain allylic hydrogens per se. The homolytic bond dissociation energy (BDE) for benzene (C6H5-H) is 110.9 kcal/mol (298 K) makes benzene resistant to autoxidization. An unsaturated compound having a hydrogen atom covalently bound to an alpha-carbon that is alpha to a Sp2-Sp2 hybridized bond, e.g., as shown as underlined in the following formula CH2═CH—CH2-CH3, is known as an allylic hydrogen and is susceptible to autoxidation.

Below is a table of bond strengths (298 K) obtained from: The handbook of Chemistry and Physics 73^{rd} edition, CRC Press. Generally the lower the C—H bond dissociation energy of a compound the greater the propensity the C—H bond to undergo autoxidation.

| Compound | BDE εH(kcal/mol) |
|---|---|
| (CH3) 3CH | 93.3 ± 0.5 |
| H—CH2OCH3) | 93 ± 1 |
| C6H5—H | 110.9 ± 2.0 |
| H—CMe2OH | 91 ± 1 |
| CH3CH3 | 100.3 ± 1 |
| CH2═CH—CH2—CH3 | 83.1 ± 2.2 |
| CH2═CH—CH3 | 86.3 ± 1.5 |
| C6H5—CH3 | 88.0 ± 1 |
| CH3CH═CHCH═CH2 | 83 ± 3 |

It is particularly important to consider the HPO content of surfactant that comprises a hydrogen atom moiety of the following form: —CH═CH—CHR—, Ar-CHR—, and/or, —O—CHR— where the hydrogen atom has a homolytic bond dissociation energy of less than 90 kcal/mol.

The following is intended as general examples of surfactants that are prone to autoxidation. When used in the present invention the hydroperoxide (HPO) level of these types of surfactants should be examined. In many instances the preparation, storage and handling thereof should be considered to keep autoxidation to a minimum.

A fatty acid soap used preferably contains from about 16 to about 22 carbon atoms, preferably in a straight chain configuration. Preferably the number of carbon atoms in the fatty acid soap is from about 16 to about 18.

This soap, in common with other anionic detergents and other anionic materials in the detergent compositions of this invention, has a cation, which renders the soap water-soluble and/or dispersible. Suitable cations include sodium, potassium, ammonium, monethanolammonium, diethanolammonium, triethanolammonium, tetramethylammonium, etc. cations. Sodium ions are preferred although in liquid formulations potassium, monoethanolammonium, diethanolammonium, and triethanolammonium cations are useful.

The soaps are frequently made from natural oils that often contain one or more unsaturated groups and consist of mixtures of components. It is clear that hydrolysation of these natural components yield mixtures of soaps. Examples of natural oils are sunflower oil, olive oil, cottonseed oil, linseed oil, safflower oil, sesame oil, palm oil, corn oil, peanut oil, soybean oil, castor oil, coconut oil, canola oil, cod liver oil and the like, that give mixtures of soaps. However, also hydrolysis products of purified oils, as listed above, may be employed. Other examples of soaps include erucic acid.

As one skilled in the art will appreciate a cationic may be manufactured, for example, by adding an alkyl halide to an amine thus forming a cationic.

In principle the cationic surfactants exhibit the same requirements as listed above for the soap materials, except they need to be quarternised. Without limiting the scope of the invention, suitable cationics may be formed by preparing the quaternary salts from alcohols that were obtained from the corresponding fatty acid. Examples of cationic surfactants based on natural oils include oleylbis(2-hydroxyethyl)methylammonium chloride and ditallow fatty alkyldimethyl ammonium chloride.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆-C₁₈ primary alcohol sulphate together with a C₁₂-C₁₅ primary alcohol 3-7 EO ethoxylate. The nonionic detergent is preferably present in amounts greater than 10%.

The low level of surfactant hydroperoxide also serves to reduce bleaching action towards unwanted substrates in a wash. By reducing the level of hydroperoxides in the bleaching composition, by virtue of low surfactant hydroperoxides, the interaction between the transition metal catalyst and a hydroperoxide is more likely to take place in the stain than elsewhere. In this manner, integrity of an item being washed with the bleaching composition of the present invention is maintained for longer in comparison to when the level of surfactant hydroperoxides is above the criteria given.

The Bleach Catalyst

The bleach catalyst per se may be selected from a wide range of transition metal complexes of organic molecules (ligands). In typical washing compositions the level of the organic substance is such that the in-use level is from 0.05 μM to 50 mM, with preferred in-use levels for domestic laundry operations falling in the range 1 to 100 μM. Higher levels may be desired and applied in industrial textile bleaching processes.

Suitable organic molecules (ligands) for forming complexes and complexes thereof are found, for example in: GB 9906474.3; GB 9907714.1; GB 98309168.7, GB 98309169.5; GB 9027415.0 and GB 9907713.3; DE 19755493; EP 999050; WO-A-9534628; EP-A-458379; EP 0909809; U.S. Pat. No. 4,728,455; WO-A-98/39098; WO-A-98/39406, WO 9748787, WO 0029537; WO 0052124, and WO0060045 the complexes and organic molecule (ligand) precursors of which are herein incorporated by reference. An example of a preferred catalyst is a transition metal complex of MeN4Py ligand (N,N-bis(pyridin-2-yl-methyl)-1,1-bis(pyridin-2-yl)-1-aminoethane).

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

A bleaching composition comprising:

a) a monomer ligand or transition metal catalyst thereof of a ligand having the formula (I):

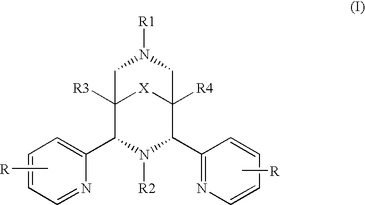

wherein each R is independently selected from: hydrogen, F, Cl, Br, hydroxyl, C1-C4-alkylO-, —NH—CO—H, —NH—CO—C1-C4-alkyl, —NH2, —NH—C1-C4-alkyl, and C1-C4-alkyl;

R1 and R2 are independently selected from:

C1-C4-alkyl,

C6-C10-aryl, and,

a group containing a heteroatom capable of coordinating to a transition metal, wherein at least one of R1 and R2 is the group containing the heteroatom;

R3 and R4 are independently selected from hydrogen, C1-C8 alkyl, C1-C8-alkyl-O-C1-C8-alkyl, C1-C8-alkyl-O-C6-C10-aryl, C6-C10-aryl, C1-C8-hydroxyalkyl, and —(CH2)ₙC(O)OR5 wherein R5 is independently selected from: hydrogen, C1-C4-alkyl, n is from 0 to 4, and mixtures thereof; and,

X is selected from C═O, —[C(R6)₂]_{y}- wherein Y is from 0 to 3 each R6 is independently selected from hydrogen, hydroxyl, C1-C4-alkoxy and C1-C4-alkyl.

The transition metal complex preferably is of the general formula (AI):

[MₐLₖXₙ]Yₘ

in which:

M represents a metal selected from Mn(II)-(III)-(IV)-(V), Cu(I)-(II)-(III), Fe (II)-(III)-(IV)-(V), Co(I)-(II)-(III), Ti(II)-(III)-(IV), V(II)-(III)-(IV)-(V), Mo(II)-(III)-(IV)-(V)-(VI) and W(IV)-(V)-(VI), preferably from Fe(II)-(III)-(IV)-(V);

L represents the ligand, preferably N,N-bis(pyridin-2-yl-methyl)-1,1-bis(pyridin-2-yl)-1-aminoethane, or its protonated or deprotonated analogue;

X represents a coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10;

n represents zero or an integer from 1 to 10;

m represents zero or an integer from 1 to 20.

Experimental

Compounds

The ligand N,N-bis(pyridin-2-yl-methyl)-1,1-bis(pyridin-2-yl)-1-aminoethane (MeN4py) was prepared as described in EP 0 909 809 A2. [Fe(MeN4py)Cl]Cl was prepared as described in WO 01/16271.

The transition metal complex dimethyl 2,4-di-(2-pyridyl)-3-methyl-7-(pyridin-2-ylmethyl)-3,7-diaza-bicyclo[3.3.1]nonan-9-one-1,5-dicarboxylate [N₂Py₃FeCl ]Cl was prepared as described in WO 02/48301.

Bleaching Experiment

In an aqueous solution of 6° FH (made by adding 6.45 ml of a stock solution containing 23.5 g/l CaCl2.2H2Oand 8.1 g/l MgCl2.6H2O2 to one liter water) containing 2 g/L of OMO MA™ Brazil, curry-oil stained cloths were added and kept in contact with the solution whilst agitating for 30 minutes at 30° C.

The cloths were washed without any additive (blank in table) and 10 μM of [N₂Py₃FeCl]Cl complex without and with addition of 1 mM of NaLAS-hydroperoxide (NaLAS-HPO; containing 130 mmol HPO per kg NaLAS-ex Albright and Wilson).

After the wash, the cloths were rinsed with water and subsequently dried at 37° C. for 2 h and the change in colour was measured with a Linotype-Hell scanner (ex Linotype. The change in colour (including bleaching) is expressed as the ΔE value versus white; a lower ΔE value means a cleaner cloth. The measured colour difference (ΔE) between the washed cloth and the unwashed cloth is defined as follows:

ΔE=[(ΔL)²+(Δa)²+(Δb)²]^{1/2}

wherein ΔL is a measure for the difference in darkness between the washed and unwashed test cloth; Δa and Δb are measures for the difference in redness and yellowness respectively between both cloths. With regard to this colour measurement technique, reference is made to Commission International de l'Eclairage (CIE); Recommendation on Uniform Colour Spaces, colour difference equations, psychometric colour terms, supplement no 2 to CIE Publication, no 15, Colormetry, Bureau Central de la CIE, Paris 1978. The results are shown below in the tables.

| | | OMO MA + |
|---|---|---|
| | OMO MA | LAS-HPO |
| Blank | 60 | 61 |
| [Fe-N2py3Cl]Cl | 42 | 52 |

The results presented in the table show that the iron compound bleaches the stain better in absence of surfactant-hydroperoxide (LAS-HPO) than in the presence of LAS-HPO.

Stability Experiment

The following demonstrates that an antioxidant may be used to reduce the formation of hydroperoxides. The amount of aldehyde formed is reflective of the degree of surfactant autoxidation. A composition containing hydroperoxides is often a dynamic composition in which radical chain reactions are occurring. Hydroperoxides result in the formation of alkoxyl radicals that can undergo beta-scission to form an aldehyde or a ketone. The hydroperoxide levels of the compositions were of monitored by examining decomposition products, aldehydes, formed from the alkali metal salt of sodium oleate.

A liquid formulation was chosen because it reflects the situation that occurs in a granular detergent but over a shorter time scale that that of the granular system.

Base formulation

| component | % |
|---|---|
| PAS | 10% |
| Nonionic surfactant, | 18.4% |
| ethoxylated fatty | |
| alcohol type | |
| Oleic acid | 10% |
| Deflocculating polymer, | 1% |
| polymer All from | |
| EP346, 995 | |
| Silicon oil to control foam | 0.03% |
| KOH | 4.1% |
| NaOH | 0.9% |
| Citric acid.H2O | 5.5% |
| Glycerol | 5% |
| Borax | 1.9% |
| Anti-dye transfer polymer | 0.3% |
| Protease | 0.3% |
| Lipolase | 0.37% |
| Amylase | 0.15% |
| Perfume | 0.47% |

Liquid formulation A was prepared with 0.03% of [Fe(MeN4py)Cl]Cl by adding 7.5 mg of the solid material in 25 ml liquid formulation A and optionally the anti-oxidant was added (resulting in 0.1%, 0.05% and 0.025%, unless denoted differently, in the formulation respectively). The mixture was stirred vigorously for 10 min and the liquids were then stored at 37° C.

The anti-oxidants employed were: BHT (2,6-di-t-butyl-4-methylphenol), Trolox (6-hydroxy-2,5,7,8-tetramethylchroman-2-carboxylic acid, Raluquin (1,2-dihydro-6-ethoxy-2,2,4-trimethylchinolin, vitamin C, Vitamin E (α-tocopherol), vitamin E-acetate (O-acetyl-α-tocopherol), and a mixture of 10% α, 45% δ- and 45% γ-tocopherol. The latter system was 70% pure; the values given in the table are corrected for this purity.

The results presented in the table below are those of liquid formulations that have been stored at ambient conditions up till 7 weeks. The measurements were made using A Fisons HRGC maga-2-series set-up using a Chrompack CP-SIL 5 CB column (50 m×0.32 mm, FD 1.2 μm). 3-Hexanone was used as an internal standard. The head-space analysis was done at 70° C.

Amounts of Aldehydes Detected by GC Analysis of the Liquid Detergent Formulations Containing Catalyst and Anti-Oxidants.

| | Antioxidant | | | | |
|---|---|---|---|---|---|
| | (% in | Weeks | | | |
| Catalyst | formul.) | storage | Octanal | Heptanal | Hexanal |
| − | − | 7 | 0.16 | 0.05 | 0.20 |
| + | − | 7 | 0.75 | 1.16 | 4.64 |
| + | Raluquin | 7 | 0.26 | 0.08 | 0.25 |
| | (0.05) | | | | |
| + | Raluquin | 7 | 0.20 | 0.07 | 0.27 |
| | (0.1) | | | | |
| + | Trolox | 7 | 0.25 | 0.17 | 0.95 |
| | (0.05) | | | | |
| + | Trolox | 7 | 0.27 | 0.10 | 0.40 |
| | (0.1) | | | | |
| + | Tocopherol- | 7 | 0.20 | 0.09 | 0.67 |
| | mix (0.17) | | | | |

1. A bleaching composition comprising at least 0.0001% wt/wt of an antioxidant, 1 to 60% wt/wt of a surfactant and an organic substance which forms a complex with a transition metal for bleaching an oily stain the bleaching composition upon addition to an aqueous medium providing an aqueous bleaching medium substantially devoid of a peroxygen bleach or a peroxy-based or peroxyl-generating bleach system, the total surfactant contribution with a HLB greater than 10 having a hydroperoxide content (HPO) less than 100 mMol/Kg.

2. A bleaching composition according to claim 1, wherein the antioxidant is present in the composition in the range 0.001 to 10%, preferably from about 0.1% to 10%, and most preferably from 0.2% to 5%.

3. A bleaching composition according claim 1, wherein the antioxidant is selected from the group consisting of: a phenol and an amine.

4. A bleaching composition according to claim 3, wherein the antioxidant is a hindered phenol.

5. A bleaching composition according claim 1, wherein the antioxidant is selected from the group consisting of: di-tert-butyl hydroxy toluene, Ethoxyquine, α-tocopherol, and 6-hydroxy-2,5,7,8-tetra-methylchroman-2-carboxylic acid.

6. A bleaching composition according claim 1, wherein the bleaching composition comprises at least 20% wt/wt of the total surfactant contribution having a HLB greater than 10.

7. A bleaching composition according claim 1, wherein the surfactant is selected from the group of cationics.

8. A bleaching composition according claim 1, wherein the surfactant is selected from the group of anionics.

9. A bleaching composition according claim 1, wherein the surfactant is selected from the group of neutral species.

10. A bleaching composition according to claim 8, wherein the surfactant is a linear alkyl benzene sulphonate.

11. A bleaching composition according claim 1, wherein the surfactant comprises an allylic hydrogen atom.

12. A bleaching composition according claim 1, wherein the surfactant comprises a hydrogen atom moiety selected from the following form: —CH═CH—CHR—; Ar-CHR—; and, —O—CHR—, wherein the hydrogen atom has a homolytic bond dissociation energy of less than 90 kcal/mol and R is a substituent.

13. A bleaching composition according claim 1, wherein the total surfactant contribution having a HLB greater than 10 has a hydroperoxide content of less than 5 mMol/Kg.

14. A bleaching composition according claim 1, wherein the surfactant is present in the composition in an amount such that a unit dose in an aqueous medium provides aqueous medium having an HPO not greater than 10 μM.
